(19) United States
(12) Patent Application Publication
(10) Pub. No.: US 2012/0109526 A1
(43) Pub. Date: May 3, 2012

(54) Method And System For Evaluating Sensor Data From A Well Service Rig

(76) Inventors: Lynn W. Conine, Houston, TX (US); Derrek Yorga, Calgary (CA)

(21) Appl. No.: 13/283,473

(22) Filed: Oct. 27, 2011

Related U.S. Application Data
(60) Provisional application No. 61/407,427, filed on Oct. 27, 2010.

(51) Int. Cl. G06F 19/00

(52) U.S. Cl. 702/6

(57) ABSTRACT

As activities are completed at a well service rig, sensors receive data and transmit it to a computer or database for storage. The sensor data, including the time it takes to complete particular activities on the rig, is evaluated to determine benchmarks. For example, data from multiple instances of an activity is organized and evaluated to determine the median value for data in that activity. Outlier data is removed and the new median and moving range is determined. A natural process limit range is then determined based on the moving range and data for each instance is compared to the natural process limit range. Instances that have data outside of the natural process limit range are noted and go through supplemental analysis to determine why the data was outside of the natural process limit range. The data can also be evaluated against activity benchmarks to determine if an activity was completed properly.

### RELATED PATENT APPLICATION

This application claims priority under 35 U.S.C. §119 to U.S. Provisional Patent Application Ser. No. 61/407,427, filed Oct. 27, 2010, and titled “Methods of Evaluating Sensor Data From a Well Service Rig and Calculating Upper and Lower Operating Limits for Activity Data from a Well Service Rig,” the entire contents of which are hereby incorporated herein by reference for all purposes.

### TECHNICAL FIELD

The present disclosure relates generally to evaluation of sensor data concerning servicing hydrocarbon wells and more specifically to an evaluation of sensor data obtained from a computerized work over rig adapted to record and transmit sensor data concerning well servicing activities and conditions at a well site.

### BACKGROUND

After drilling a hole through a subsurface formation and determining that the formation can yield an economically sufficient amount of oil or gas a crew completes the well. Once completed, a variety of events may occur to the formation causing the well and its equipment to require a “work-over.” For purposes of this application, “work-over” and “service” operations are used in their very broadest sense to refer to all activities performed on or for a well to repair or rehabilitate the well, and also includes activities to shut in or cap the well. Generally, workover operations include such things as replacing worn or damaged parts (e.g., a pump, sucker rods, tubing, and packer glands), applying secondary or tertiary recovery techniques, such as chemical or hot oil treatments, cementing the wellbore, and logging the wellbore, to name just a few.

During drilling, completion, and well servicing, personnel routinely insert into and/or extract equipment such as tubing, tubes, pipes, rods, hollow cylinders, casing, conduit, collars, and duct from the well. For example, a service crew may use a workover or service rig (collectively hereinafter “service rig” or “rig”) that is adapted to complete a number of activities at the well, including, but not limited to, pulling the well tubing or rods out of the well, setting tubing anchors, and also to run the tubing or rods back into the well. Typically, these mobile service rigs are motor vehicle-based and have an extendible, jack-up derrick complete with draw works and block and have numerous sensors that receive data as the activities are being completed at the well. In most cases the data from these sensors and other input devices are recorded and stored in case they need to be subsequently evaluated. Over time, a significant amount of data for numerous instances of an activity completed on different rigs and by different work crews is collected. Finding ways to use that data to improve operations, evaluating whether activities are being completed properly and improve safety for the rig crew would improve the overall operation of the rig as it completes the activities in the future.

### SUMMARY

The exemplary embodiments described herein describe systems and methods for evaluating sensor, time and activity data obtained by a well service rig or vehicle while it is conducting activities near a well and using that evaluation of data to, for example, determine if the activity was completed properly, set benchmarks based on an evaluation of numerous activities and compare data to the benchmarks to determine instances of activities that are outside a natural process limits for that particular benchmark. For one aspect of the present invention, a computer-implemented method for evaluating data from a well service rig can include the step of receiving a collection of data, wherein the collection of data includes data for multiple instances of an activity completed by a well service rig at a wellsite. The method can also include the step of conducting a gross error review of the collection of data. In addition, the method can include the step of conducting a tech limit activity review of the collection of data. Furthermore, the exemplary method can include the step of generating a report for the instances of the activity.

For another aspect of the present invention, a computer-implemented method for determining a trip activity coefficient for an activity completed by a well service rig can include the step of receiving, a multiple data entries for a single instance of the activity completed by the well service rig. The method can also include the step of evaluating a first portion of the multiple data entries to determine a gross time or total time to complete the activity. The method can also include the step of evaluating another portion of the multiple data entries to determine a portion of the gross time that the well service rig conducted operations during the instance of the activity and can designate that portion of the gross time as work time. In addition, the exemplary method can include the step of calculating the trip activity coefficient for that instance of the activity.

For yet another aspect of the present invention, a computer-implemented method for determining if a tubing anchor was set properly by a well service rig can include the step of receiving multiple entries of load data collected during an instance of setting the tubing anchor with the well service rig. The method can also include the step of receiving multiple entries of block position data collected during the instance. The method can also include the step of evaluating the multiple entries of load data to determine if there is a first portion of the load data that increases to a string weight. In addition, the exemplary method can include the step of evaluating the multiple entries of block position data to identify a first period where a first portion of the block position data shows that a block is moving upward. Also, the exemplary method can include the step of evaluating the load data to determine if during the first period, the load increases a first nominal amount. Further, the exemplary method can include the step of evaluating the block position data to determine if a second period exists after the first period where a second portion of the block position data shows that the block is moving downward. The method can also include the step of evaluating the load data to determine if during the second period, the load decreases a second nominal amount. In addition, the method can include the step of evaluating the block position data to determine if a third period exists after the second period where a portion of the block position data shows that the block is moving upward. Further, the method can include the step of evaluating the load data to determine if during the third period, the load increases a third nominal amount. Also, the method can include the step of evaluating the block position data to determine if a fourth period exists after the third period where a portion of the block position data shows that the block is moving downward. The method can also include the step of evaluating the load data to determine if during the fourth period, the load decreases a fourth nominal amount. In addition, the method can include the step of evaluating the block position data and the load data to determine if a fifth period exists after the fourth period where a fifth portion of the block position data and the load data are substantially stable for a predetermined amount of time. Further, the method can include the step of generating a positive notification that the tubing anchor was set properly based on a positive determination in the determining steps.

### BRIEF DESCRIPTION OF THE DRAWINGS

Reference will now be made to the accompanying drawings, which are not necessarily drawn to scale, and wherein:

FIG. 1 is a side view of an exemplary mobile repair unit with its derrick extended according to one exemplary embodiment;

FIG. 2 is a side view of the exemplary mobile repair unit with its derrick retracted according to one exemplary embodiment;

FIG. 3 is an electrical schematic of a monitor circuit according to one exemplary embodiment;

FIG. 4 illustrates the raising and lowering of an inner tubing string with an exemplary mobile repair unit according to one exemplary embodiment;

FIG. 5 illustrates one embodiment of an activity capture methodology outlined in tabular form according to one exemplary embodiment;

FIG. 6 provides a frontal view of an exemplary operator interface according to one exemplary embodiment;

FIG. 7 is a schematic diagram of an exemplary data management system according to one exemplary embodiment;

FIG. 8 is a flow chart presenting a method for evaluating sensor and activity data according to one exemplary embodiment;

FIG. 9 is a flow chart presenting a method for gross error review of sensor data and activity data in accordance with one exemplary embodiment;

FIG. 10 is a flow chart presenting a method for tech limit activity review of sensor data and activity data in accordance with one exemplary embodiment;

FIG. 11 is a flow chart presenting a method for conducting additional analysis of sensor data and activity data in accordance with one exemplary embodiment;

FIG. 12 is a flow chart presenting a method for conducting data mining of sensor data and activity data in accordance with one exemplary embodiment;

FIG. 13 is a flow chart presenting a method for determining the number of stands pulled out of or run into a whole during an activity in accordance with one exemplary embodiment;

FIG. 14 is a flow chart presenting a method for verifying that a tubing anchor catcher was set correctly in accordance with one exemplary embodiment;

FIG. 15 is a table presenting an example of the steps in the gross error review and tech limit activity review of FIG. 9 for representative data in accordance with one exemplary embodiment;

FIG. 16 is a table presenting certain exemplary calculations from the gross error review and tech limit activity review of FIG. 15 in accordance with one exemplary embodiment;

FIG. 17 is a table presenting an exemplary calculation of median for data in the gross error review and tech limit activity review of FIG. 15 in accordance with one exemplary embodiment of the present invention;

FIG. 18 is a representative job efficiency report in accordance with one exemplary embodiment of the present invention; and

FIGS. 19A-C are a representative job summary report in accordance with one exemplary embodiment of the present invention.

The drawings illustrate only exemplary embodiments of the invention and are therefore not to be considered limiting of its scope, as the invention may admit to other equally effective embodiments. The elements and features shown in the drawings are not necessarily to scale, emphasis instead being placed upon clearly illustrating the principles of the exemplary embodiments. Additionally, certain dimensions or positionings may be exaggerated to help visually convey such principles. In the drawings, reference numerals designate like or corresponding, but not necessarily identical, elements.

### DETAILED DESCRIPTION OF THE EXEMPLARY EMBODIMENTS

Exemplary embodiments will now be described in detail with reference to the included figures. The exemplary embodiments are described in reference to how they might be implemented. In the interest of clarity, not all features of an actual implementation are described in this specification. Those of ordinary skill in the art will appreciate that in the development of an actual embodiment, several implementation-specific decisions must be made to achieve the inventors' specific goals, such as compliance with system-related and business-related constraints which can vary from one implementation to another. Moreover, it will be appreciated that such a development effort might be complex and time-consuming, but would nevertheless be a routine undertaking for those of ordinary skill in the art having benefit of this disclosure. Further aspects and advantages of the various figures of the invention will become apparent from consideration of the following description and review of the figures. While references are generally made hereinafter to rods, tubing, or casing specifically, with the description of the figures, each reference should be read broadly to include rods, tubing, casing, piping, and other downhole equipment unless specifically limited therein.

The exemplary embodiments are also directed to retrieval and evaluation of sensor data obtained during activities at a workover or well-service rig and, in certain embodiments, calculating upper and lower limits for activity data derived from the workover or well-service rig (collectively the “well-service rig” or “rig”). The exemplary embodiments support computer-implemented methods and systems for the retrieval and analysis of the sensor data, time data, and activity data from the well-service rig in a networked or stand-along computing system. Furthermore the exemplary system, or portions thereof, can be located at or adjacent to the well-service rig or at a location remote from the well-service rig, such as a shop, business office or business headquarters.

In a distributed computing environment, program modules and the sensor data obtained from the well-service rig may be physically located in different local and remote memory storage devices or databases. Execution of the program modules may occur locally in a stand-alone manner or remotely in a client/server manner. Examples of such distributed computing environments include local area networks, enterprise wide computer networks, and the global Internet.

The detailed description that follows is represented largely in terms of processes and symbolic representations of operations by conventional computing components, including processing units, memory storage devices, databases, display devices, and input devices. These processes and operations may utilize conventional computer components in a stand-alone or distributed computing environment.

The processes and operations performed by the computer include the manipulation of signals by a processing unit or remote computer and the maintenance of these signals within data structures resident in one or more of the local or remote memory storage devices. Such data structures impose a physical organization upon the collection of data stored within a memory storage device and represent specific, electrical or magnetic elements. The symbolic representations are the means used by those skilled in the art of computer programming and computer construction to most effectively convey teachings and discoveries to others skilled in the art.

Exemplary embodiments of the present invention include a computer program that embodies the functions described herein and illustrated in the flowcharts. However, it should be apparent that there could be many different ways of implementing the invention in computer programming, and the invention should not be construed as limited to any one set of the computer program instructions. Furthermore, a skilled programmer would be able to write such a computer program to implement a disclosed embodiment of the present invention without difficulty based, for example, on the tables and flowcharts and associated description in the application text. Therefore, disclosure or a particular set of program code instructions is not considered necessary for an adequate understanding of how to make and use the present invention.

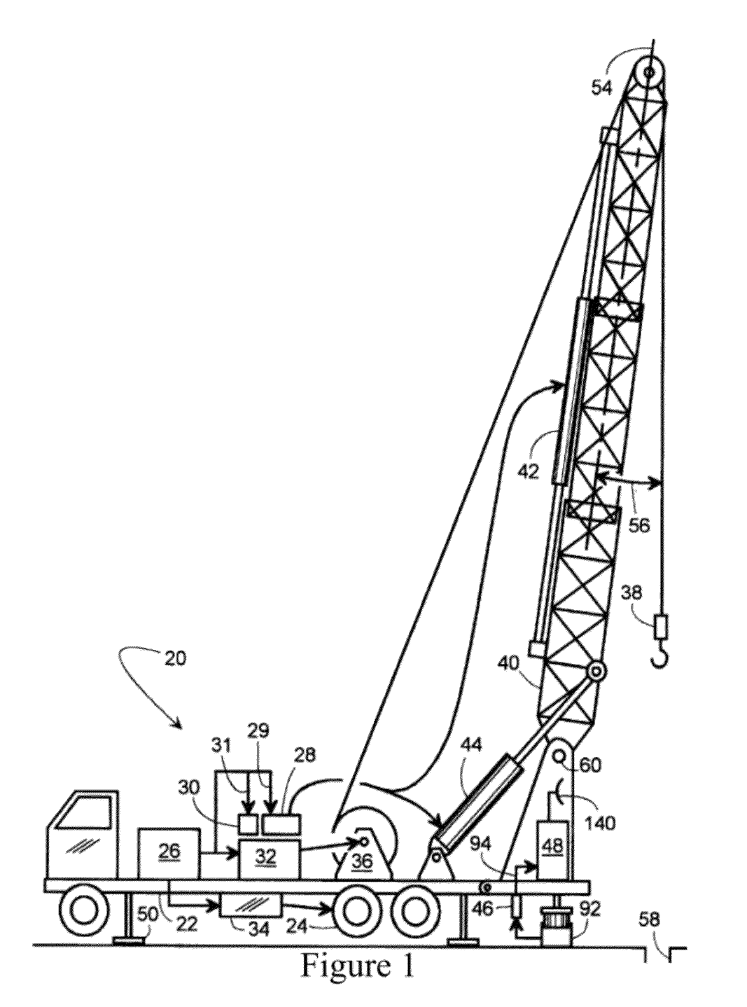

Referring to FIG. 1, a retractable, self-contained mobile repair unit 20 is presented to include a truck frame 22 supported on wheels 24, an engine 26, a hydraulic pump 28, an air compressor 30, a first transmission 32, a second transmission 34, a variable speed hoist 36, a block 38, an extendible derrick 40, a first hydraulic cylinder 42, a second hydraulic cylinder 44, a first transducer 46, a monitor 48, and retractable feet 50.

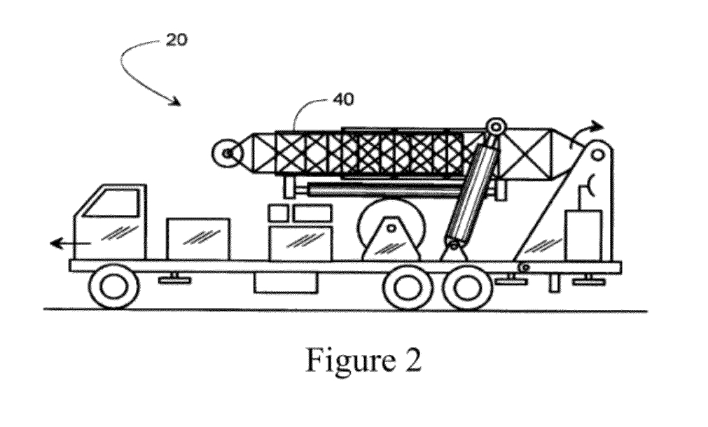

The engine 26 selectively couples to the wheels 24 and the hoist 36 by way of the transmissions 34 and 32, respectively. The engine 26 also drives the hydraulic pump 28 via the line 29 and the air compressor 30 via the line 31. The compressor 30 powers a pneumatic slip (Not Shown), and the pump 28 powers a set of hydraulic tongs (Not Shown). The pump 28 also powers the cylinders 42 and 44 which respectively extend and pivot the derrick 40 to selectively place the derrick 40 in a working position, as shown in FIG. 1, and in a lowered position, as shown in FIG. 2. In the working position, the derrick 40 is pointed upward, but its longitudinal centerline 54 is angularly offset from vertical as indicated by the angle 56. The angular offset provides the block 38 access to a wellbore 58 without interference with the derrick pivot point 60. With the angular offset 56, the derrick framework does not interfere with the typically rapid installation and removal of numerous inner pipe segments (known as pipe, inner pipe string, rods, or tubing 62, hereinafter interchangeably referred to in a non-limiting manner as “tubing” or “rods”).

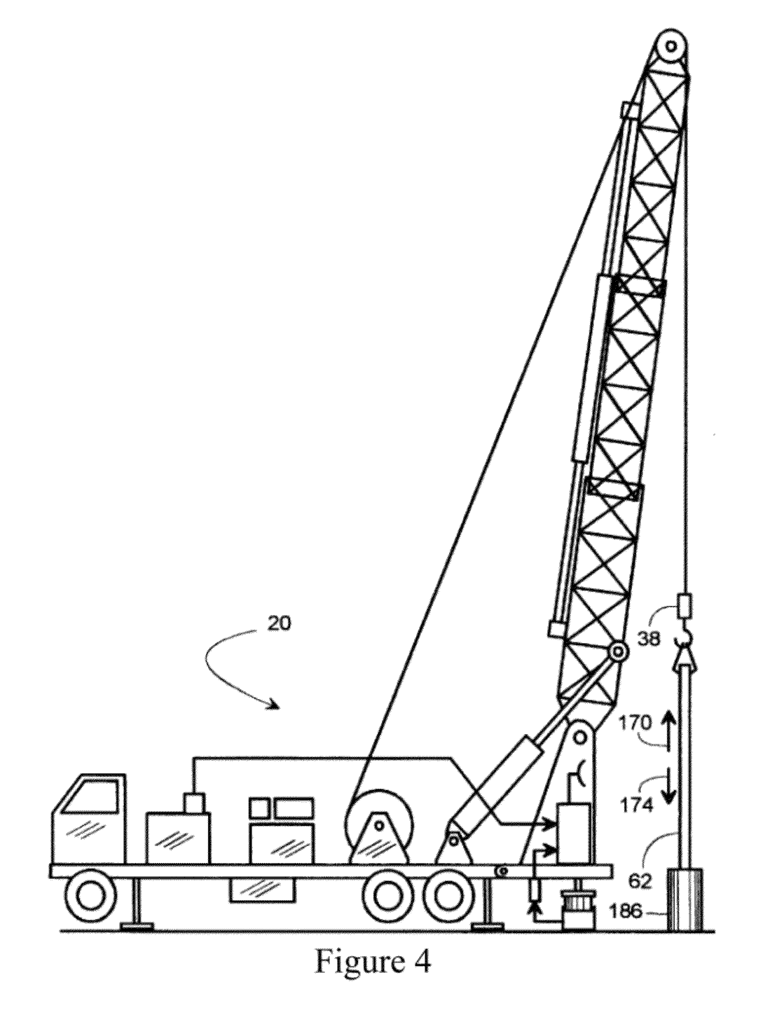

Individual pipe segments (of string 62 in FIG. 4) and sucker rods are screwed to themselves using hydraulic tongs. The term “hydraulic tongs” used herein and below refer to any hydraulic tool that can screw together two pipes or sucker rods. In operation, the pump 28 drives a hydraulic motor (Not Shown) forward and reverse by way of a valve. Conceptually, the motor drives the pinions which turn a wrench element relative to a clamp. The element and clamp engage flats on the mating couplings of a sucker rod or an inner pipe string 62 of one conceived embodiment of the invention. However, it is well within the scope of the invention to have rotational jaws or grippers that clamp on to a round pipe (i.e., no flats) similar in concept to a conventional pipe wrench, but with hydraulic clamping. The rotational direction of the motor determines assembly or disassembly of the couplings.

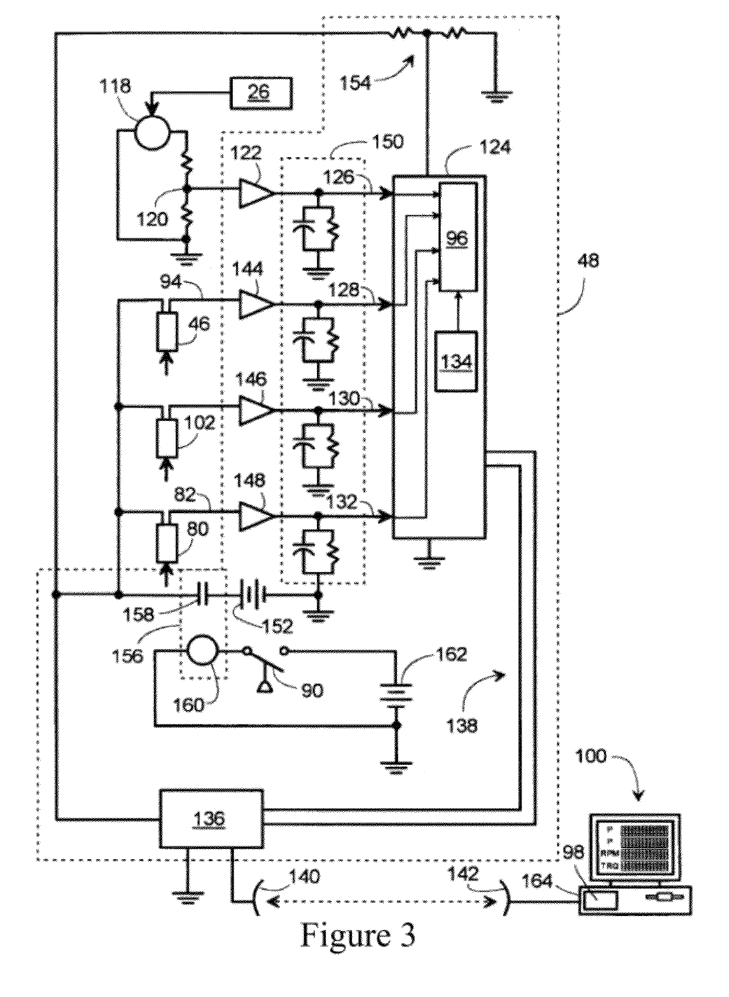

While not explicitly shown in the figures, when installing the tubing segments 62, the pneumatic slip is used to hold the tubing 62 while the next segment of tubing 62 is screwed on using tongs. A compressor 30 provides pressurized air through a valve to rapidly clamp and release the slip. A tank helps maintain a constant air pressure. Pressure switch provides the monitor 48 (FIG. 3) with a signal that indirectly indicates that the rig 20 is in operation.

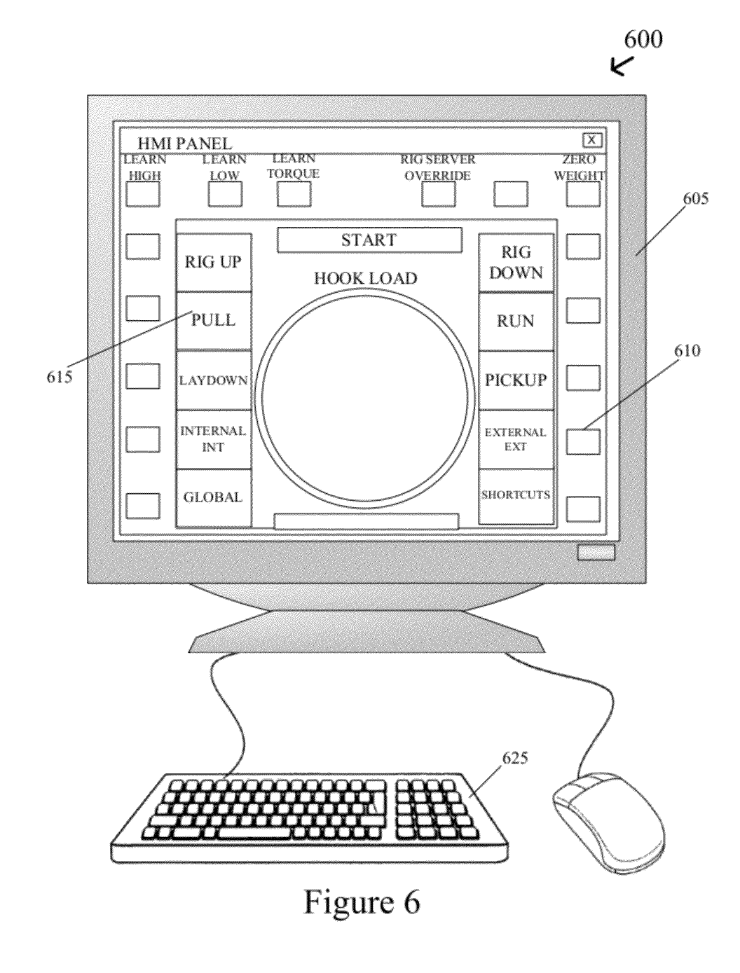

Referring back to FIG. 1, weight applied to the block 38 is sensed by way of a hydraulic pad 92 that supports the weight of the derrick 40. The hydraulic pad 92 is basically a piston within a cylinder (alternatively a diaphragm). Hydraulic pressure in the pad 92 increases with increasing weight on the block 38. In FIG. 3, the first transducer 46 converts the hydraulic pressure to a 0-5 VDC signal 94 that is conveyed to the monitor 48. The monitor 48 converts signal 94 to a digital value, stores it in a memory 96, associates it with a real time stamp, and eventually communicates the data to a remote computer 100 or the computer 605, of FIG. 6, by way of hardwire, a modem 98, T1 line, WiFi, satellite, portable data storage means, such as compact disc (CD), dongle, digital video disc (DVD), tape drive, portable hard drive, disc or other device or method for transferring data known to those of ordinary skill in the art.

Returning to FIG. 3, transducers 46 and 102 are shown coupled to the monitor 48. The transducer 46 indicates the pressure on the left pad 92 and the transducer 102 indicates the pressure on the right pad 92. A generator 118 driven by the engine 26 provides an output voltage proportional to the engine speed. This output voltage is applied across a dual-resistor voltage divider to provide a 0-5 VDC signal at point 120 and then passes through an amplifier 122. A generator 118 represents just one of many various tachometers that provide a feedback signal proportional to the engine speed. Another example of a tachometer would be to have engine 26 drive an alternator and measure its frequency. The transducer 80 provides a signal proportional to the pressure of hydraulic pump 28, and thus proportional to the torque of the tongs.

A telephone accessible circuit 124, referred to as a “POCKET LOGGER” by Pace Scientific, Inc. of Charlotte, N.C., includes four input channels 126, 128, 130 and 132; a memory 96 and a clock 134. The circuit 124 periodically samples inputs 126, 128, 130 and 132 at a user selectable sampling rate; digitizes the readings; stores the digitized values; and stores the time of day that the inputs were sampled. It should be appreciated by those skilled in the art that with the appropriate circuit, any number of inputs can be sampled and the data could be transmitted instantaneously upon receipt.

A supervisor at a computer 100 remote from or adjacent to the work site at which the service rig 20 is operating accesses the data stored in the circuit 124 by way of a PC-based modem 98 or cable modem and a cellular phone 136, satellite, WiFi or other known methods for wired or wireless data transfer. The phone 136 reads the data stored in the circuit 124 via the lines 138 (RJ11 telephone industry standard) and transmits the data to the modem 98 by way of antennas 140 and 142.

The amplifiers 122, 144, 146 and 148 condition their input signals to provide corresponding inputs 126, 128, 130 and 132 having an appropriate power and amplitude range. Sufficient power is needed for RC circuits 150 which briefly (e.g., 2-10 seconds) sustain the amplitude of inputs 126, 128, 130 and 132 even after the outputs from transducers 46, 102 and 80 and the output of the generator 118 drop off. This ensures the capturing of brief spikes without having to sample and store an excessive amount of data. A DC power supply 152 provides a clean and precise excitation voltage to the transducers 46, 102 and 80; and also supplies the circuit 124 with an appropriate voltage by way of a voltage divider 154. A pressure switch 90 enables the power supply 152 by way of the relay 156, whose contacts 158 are closed by the coil 160 being energized by the battery 162. FIG. 4 presents an exemplary display representing a service rig 20 lowering an inner pipe string 62 as represented by arrow 174 of FIG. 4.

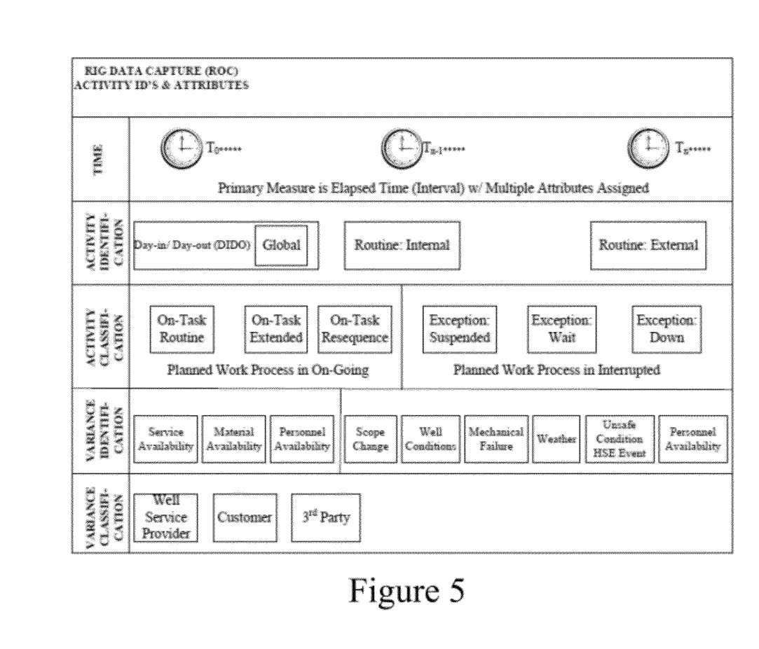

FIG. 5 provides an illustration of an activity capture methodology in tabular form according to one exemplary embodiment of the present invention. Now referring to FIG. 5, an operator first chooses an activity identifier for his/her upcoming task. If “GLOBAL” is chosen, then the operator would choose from rig up/down, pull/run tubing or rods, or laydown/pickup tubing and rods (options not shown in FIG. 6). If “ROUTINE: INTERNAL” is selected, then the operator would choose from rigging up or rigging down an auxiliary service unit, longstroke, cut paraffin, nipple up/down a BOP, fishing, jarring, swabbing, flowback, drilling, clean out, well control activities such as killing the well or circulating fluid, unseating pumps, set/release tubing anchor, set/release packer, and pick up/laydown drill collars and/or other tools. Finally, if “ROUTINE: EXTERNAL” is chosen, the operator would then select an activity that is being performed by a third party, such as rigging up/down third party servicing equipment, well stimulation, cementing, logging, perforating, or inspecting the well, and other common third party servicing tasks. After the activity is identified, it is classified. For all classifications other than “ON TASK: ROUTINE,” a variance identifier is selected, and then classified using the variance classification values.

FIG. 6 provides a view of an rig operator interface or supervisor interface according to one exemplary embodiment of the present invention. Now referring to FIG. 6, all that is required from the operator is that he or she input in the activity data into a computer 605. The operator can interface with the computer 605 using a variety of means, including typing on a keyboard 625 or using a touch-screen 610. In one embodiment, a touch-screen display 610 with pre-programmed buttons, such as pulling rods or tubing from a wellbore 615, is provided to the operator, as shown in FIG. 6, which allows the operator to simply select the activity from a group of pre-programmed buttons. For instance, if the operator were presented with the display 610 of FIG. 6 upon arriving at the well site, the operator would first press the “RIG UP” button. The operator would then be presented with the option to select, for example, “SERVICE UNIT,” “AUXILIARY SERVICE UNIT,” or “THIRD PARTY.” The operator then would select whether the activity was on task, or if there was an exception, such as WAIT TIME or MACHINE DOWN, as described above. In addition, as shown in FIG. 6, prior to pulling (removing) 615 or running (inserting) rods 62, the operator could set the high and low limits for the block 38 by pressing the learn high or learn low buttons after moving the block 38 into the proper position.

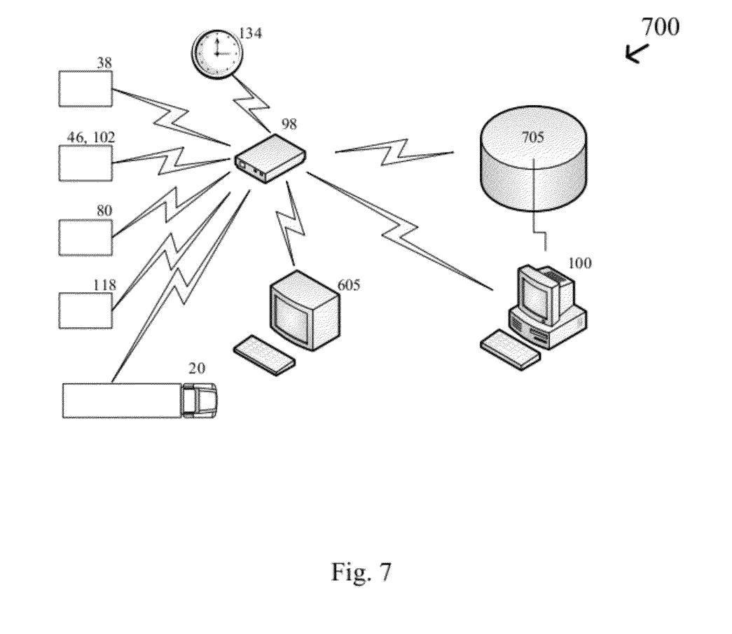

FIG. 7 is a schematic diagram of an exemplary data management system 700 for receiving and evaluating data received from sensors and from the rig 20 according to one exemplary embodiment. Referring now to FIGS. 1-7, the data management system 700 includes data that is received from the sensors 38, 46, 102, 80, 118 and any other sensors on the rig 20 or used during an activity with the rig 20, even if not physically connected to the rig 20. Other data, including but not limited to, timing data for each activity from the clock 134 or other operational or activity data from the rig 20 is also acquired and transmitted by the system 700. The data is transmitted from the rig 20 or from a device near the rig to a database 705 and/or the computer 100 for storage and evaluation of the data. The data can also be transmitted to the display 610 of the computer 605 for evaluation by the rig operator. In one exemplary embodiment, the data is transmitted with a modem 98. Alternatively, the data can be wired or wirelessly communicated to the computer 605, database 705 and/or computer 100 by way of electrical cable, WiFi, satellite transmission, cellular transmission or any other means of data transmission known to those of ordinary skill in the art. While not shown in FIG. 7, the rig 20 can also include a device, such as a database, dongle, compact disc drive, DVD drive or similar means for recording and storing the data at the rig 20. In addition, while the exemplary embodiment describes the system having one analysis computer 100 for receiving and analyzing the data, the system 700 can alternatively include multiple general purpose computers or multiple general purpose processors within a computer, set of computers or mainframe system for receiving and analyzing the data from the sensors.

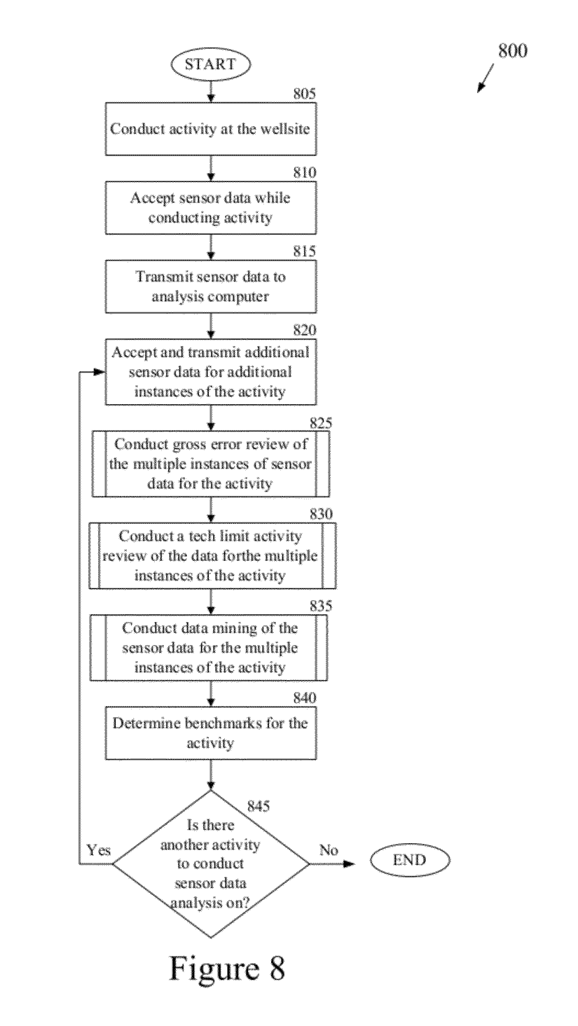

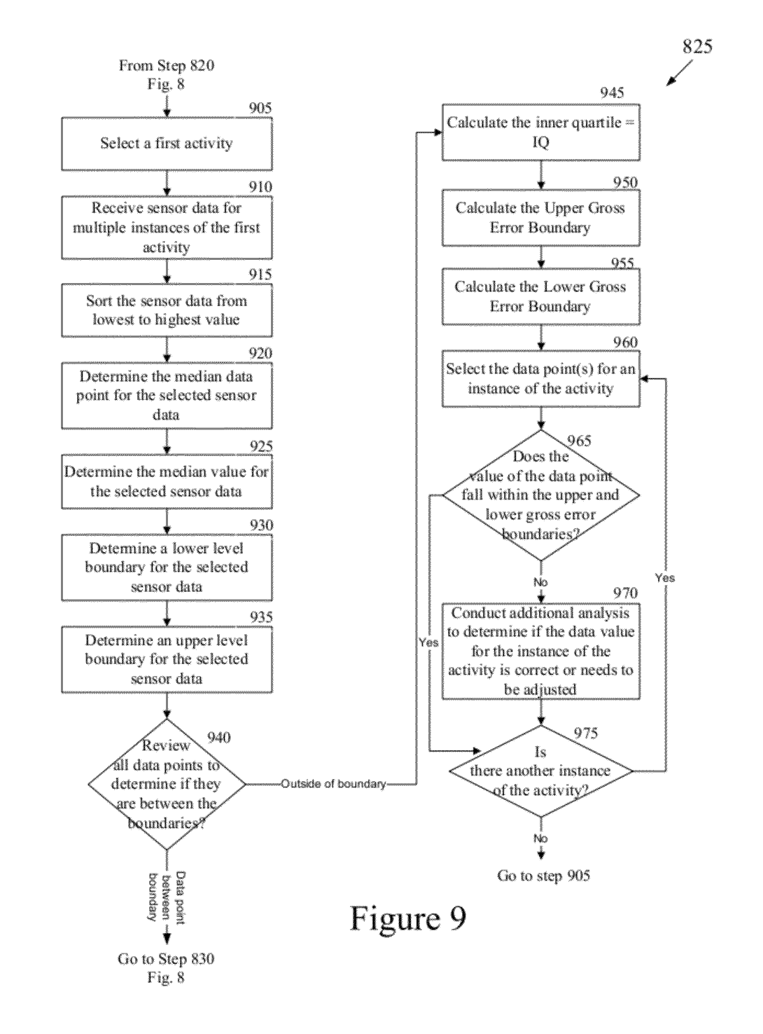

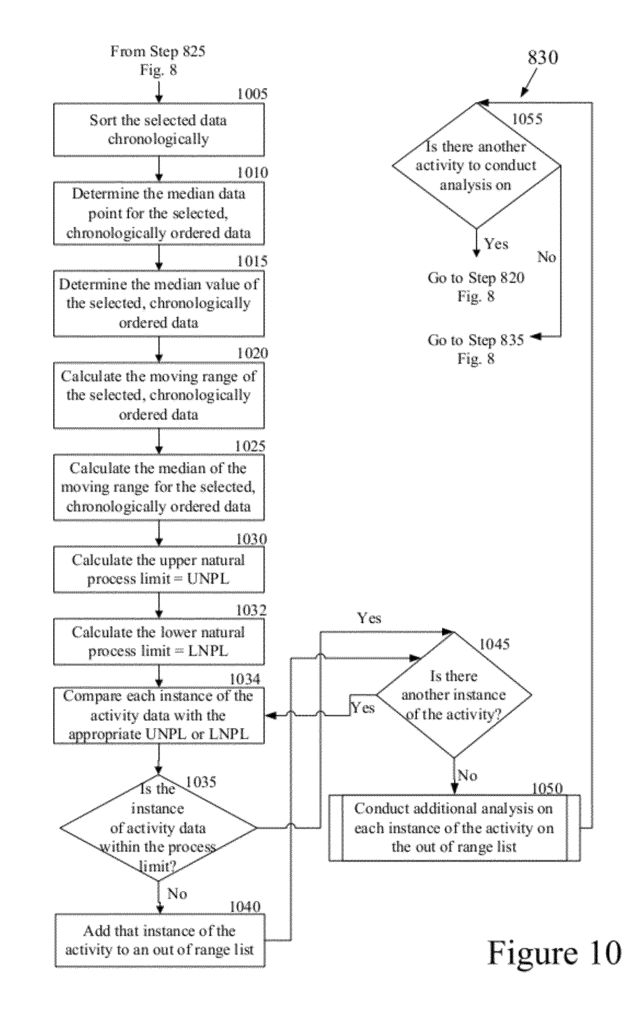

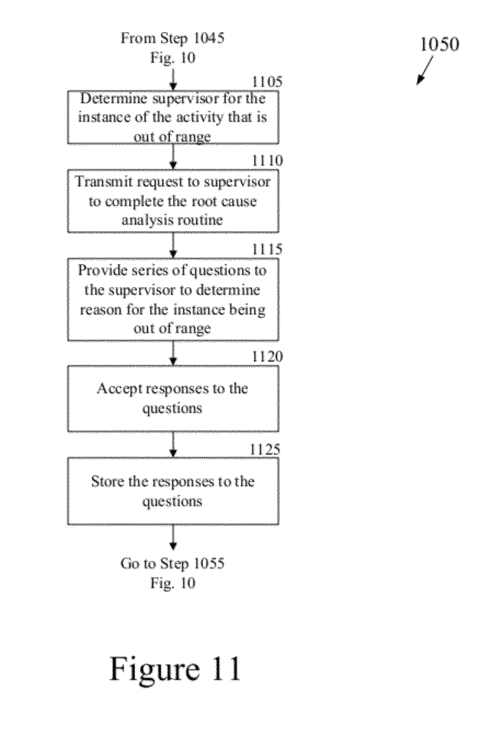

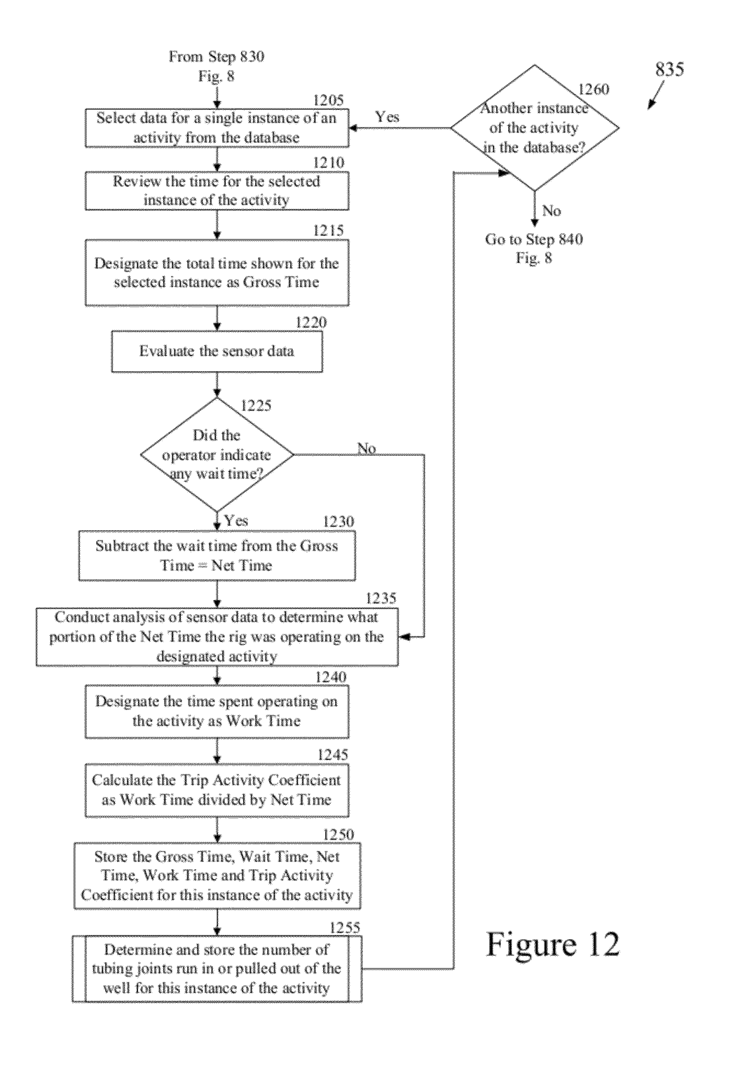

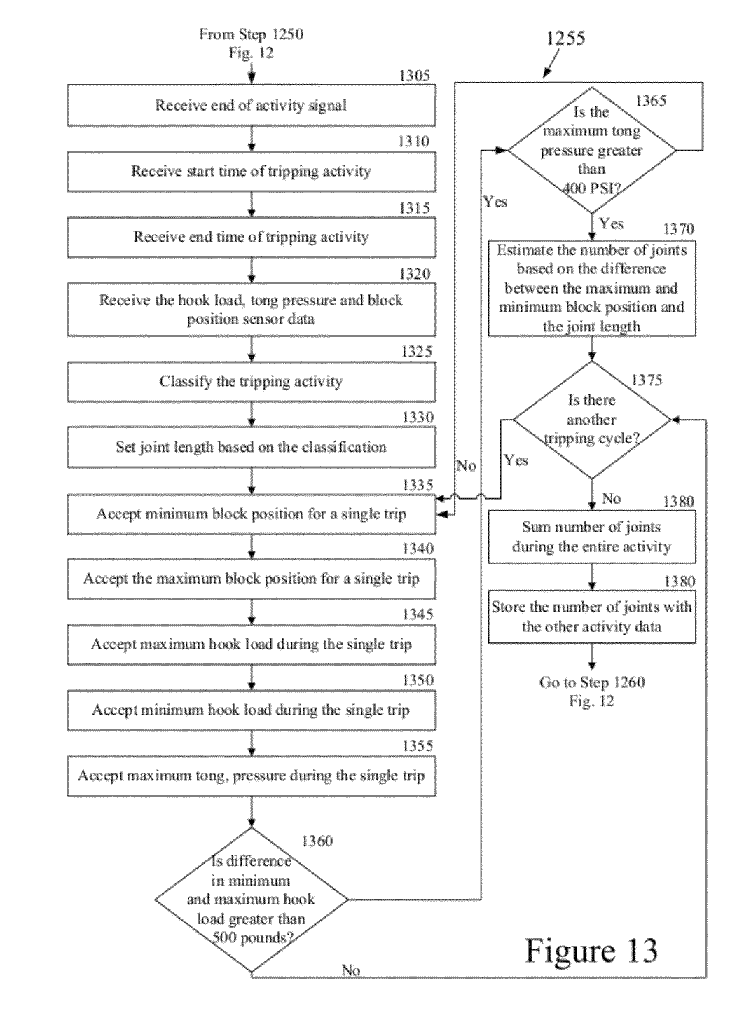

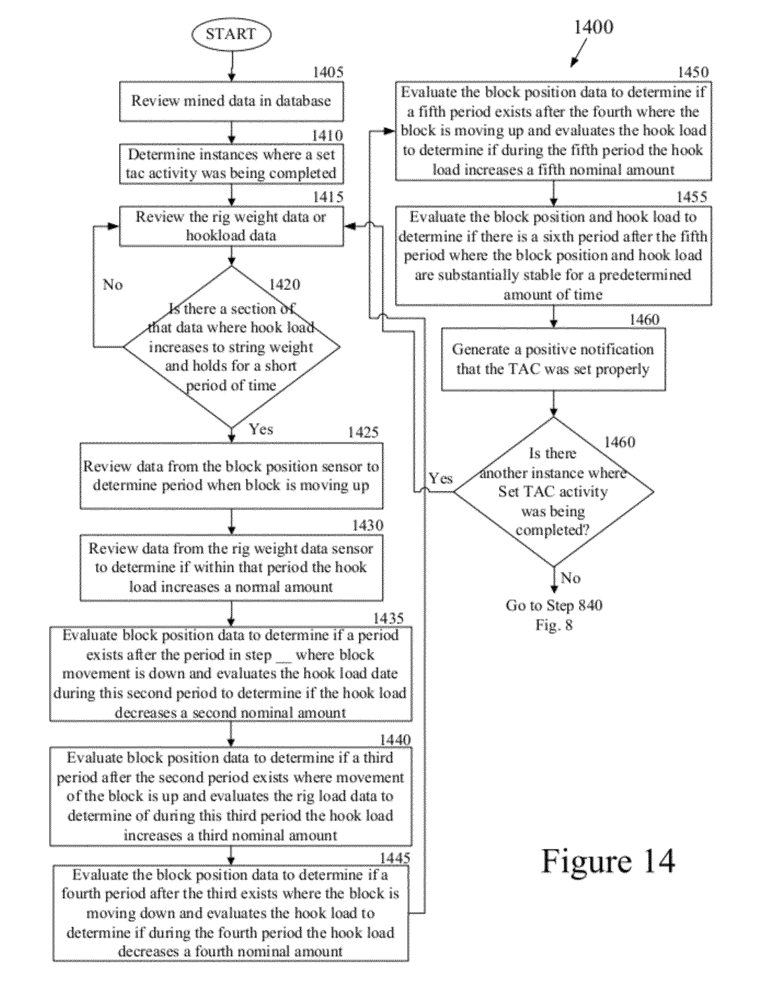

FIG. 8 is a flow chart presenting a method for evaluating sensor and activity data according to one exemplary embodiment. Referring now to FIGS. 1-8, the exemplary method 800 begins at the START step and proceeds to step 805, where an activity is conducted at the wellsite. The activity is typically conducted with the rig 20 and sensors (such as those described in FIG. 7) record data during the activity and the clock 134 records the time to complete the activity. In one exemplary embodiment, the well-service rig 20 can be as substantially described in U.S. Pat. No. 6,079,490 (the “'490 Patent”) and U.S. Pat. No. 7,006,920 (the “'920 Patent”), the entire contents of which are hereby incorporated herein by reference. The activities can include any activity typically accomplished with a well-service rig, including, but not limited to, rig up service unit, kill well, pull out of the hole rods, pick up tubing, lay down tubing, pull out of hole tubing while scanning, run in hole tubing while hydro testing, pick up rods, lay down rods, pull out of the hole tubing, nipple-up blow out preventer (BOP), run in the hole rods, run in the hole tubing, set tubing anchor catcher, rig down the service unit.

In step 810, the sensor data and time data (which can include one or more types of sensor data obtained by sensors on or electrically coupled or associated with the well-service rig 20) is received at the display while the activity is being conducted at the wellsite by the rig 20. The sensor and time data is transmitted or transported (when stored on a physically transportable storage medium using, for example, a memory stick, hard drive, portable hard drive, CD, DVD, dongle or the like) to the analysis computer 100 or “portal” or the database 705 in step 815. The terms analysis computer 100 and portal will be used interchangeably herein. In one exemplary embodiment, the sensor and time data are transmitted from the rig 20 by the modem 98 to the database 705 and subsequently provided to the analysis computer 100, which is communicably coupled to the database 705. Alternatively, the sensor and time data are transmitted by wired or other wireless communication from the rig 20 to the database 705 or analysis computer 100.

In step 820, the analysis computer 100 receives the sensor or time data for the particular instance of the activity and receives similar sensor or time data for additional instances of the activity from the database 705. In one exemplary embodiment, the activity sensor data or time data for multiple instances of the activity have been collected from multiple well-service rigs conducting this activity at multiple wellsites and by multiple crews and is stored in the database 705, or other memory storage device known to those of ordinary skill in the art, until it is analyzed and evaluated by the analysis computer 100. In certain exemplary embodiments, the retrieval and analysis of multiple instances of the activity are alternatively described with regards to the method of data mining described in greater detail in FIG. 12 below. In one exemplary embodiment, the data received at the analysis computer 100 for the multiple instances of a particular activity is data representing the amount of time it took to complete that instance of the activity. Alternatively, other sensor data for each instance of an activity is received an analyzed by the analysis computer 100. Further, in certain exemplary embodiments, the analysis is completed on multiple instances of each particular activity or sub-activity completed by the rig crew at the wellsite.

In step 825, a gross error review of the data for the multiple instances of the particular activity being evaluated is completed. In one exemplary embodiment, the gross error review is completed by the analysis computer 100. A tech limit activity review of the data for the multiple instances of the particular activity is completed in step 830. In one exemplary embodiment, the tech limit activity review is completed by the analysis computer 100. In step 835, data mining for particular data related to one or more activities is completed in step 835. In one exemplary embodiment, the data mining is completed by the analysis computer 100, which retrieves and analyzes the data being stored in the database 705. Benchmarks and metrics for quality and quantitative improvements based on the analysis conducted in steps 825-835 for the particular activity based on the received data are determined in step 840. In certain exemplary embodiments, the benchmarks are determined by the analysis computer 100. The process is iterative in that the process will repeat for each activity and sub-activity for which activity data is recorded at the well service rig 20 and the data, scorecards, and reports can be updated on a daily, weekly, monthly or more or less frequent basis depending on the desires of the party implementing the exemplary system and methods

In step 845, an inquiry is conducted to determine if there is another activity on which to conduct an analysis of sensor or time data. The determination can be made by the analysis computer 100 evaluating the types of activities being completed by the rig 20 or the types of activity for which sensor or time data is stored in the database 705 or within the internal storage of the computer 100. If there is another activity to evaluate, the YES branch is followed to step 820, where the analysis computer 100 receives the sensor or time data for the next activity. Otherwise, the NO branch is followed to the END step.

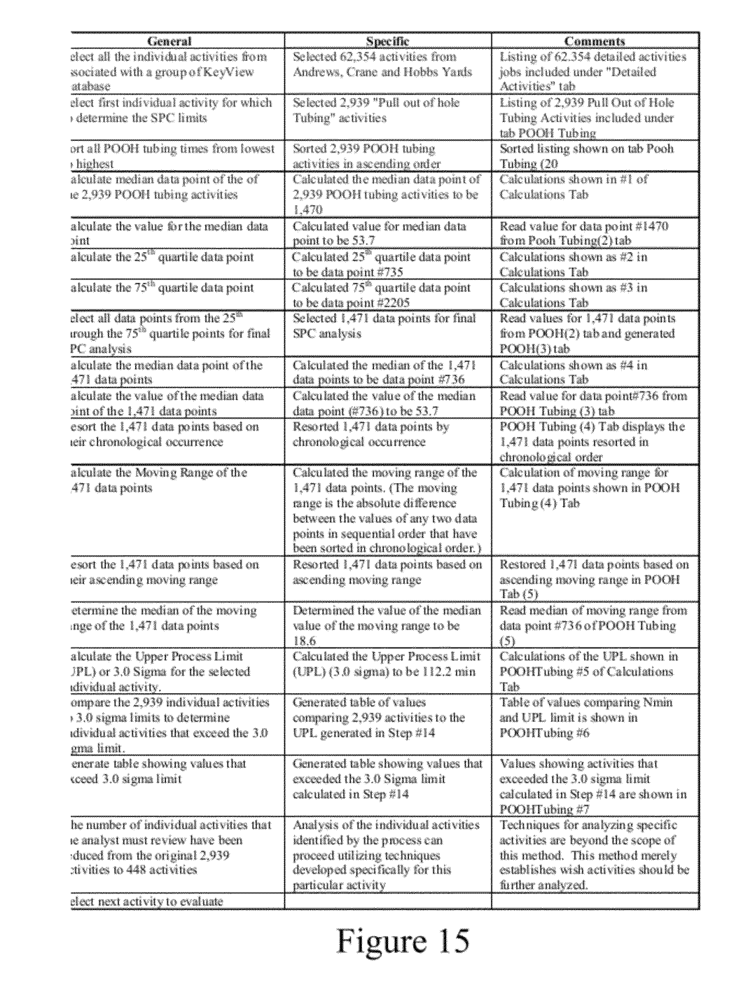

FIG. 9 is a flow chart presenting a method 825 for conducting gross error review of sensor or time data for an activity according to one exemplary embodiment. FIG. 15 is a table presenting an example of the steps in FIGS. 9 and 10. Now referring to FIGS. 1-9 and 15, the exemplary method 825, begins at step 905, where the analysis computer 100 selects all of the individual activities associated with a group of jobs with data stored in the memory storage device or database 705 and then selects the first individual activity type from the multiple activity types to analyze. In the exemplary embodiment of FIG. 15, the first activity type is pulling out of hole tubing (POOH tubing). In step 910, the analysis computer 100 receives the sensor data or time data for multiple instances of the selected activity. In one exemplary embodiment, the times to complete each instance of the activity are received by the analysis computer 100 from the memory storage device or database 705. The sensor data or time data received is sorted from lowest value to highest value in step 915. For example, when the data received is the completion time for each instance of the activity of POOH tubing, the analysis computer 100 sorts the group of completion times for the POOH tubing from lowest to highest. In an alternative embodiment, the completion times or other sensor data are sorted from highest to lowest, sorted in another manner, or not sorted at all.

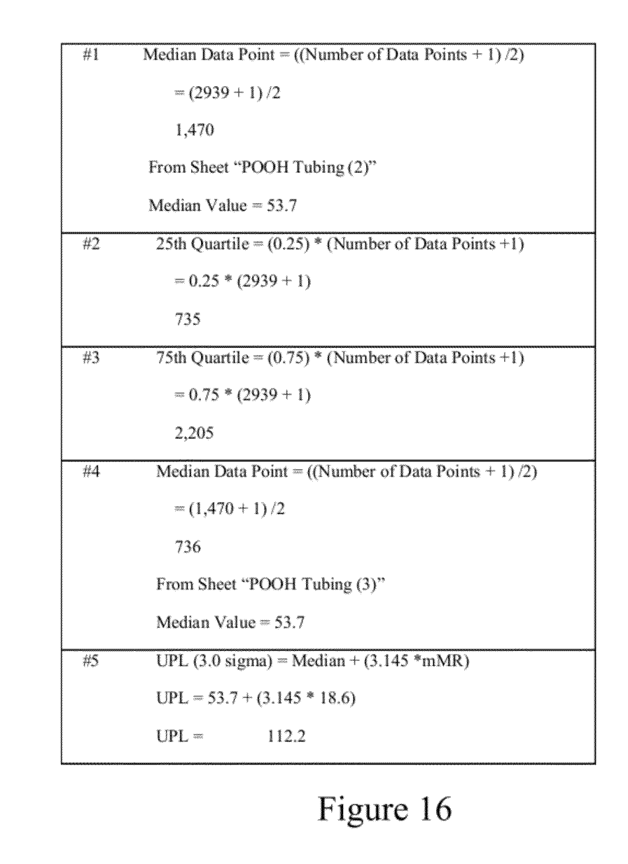

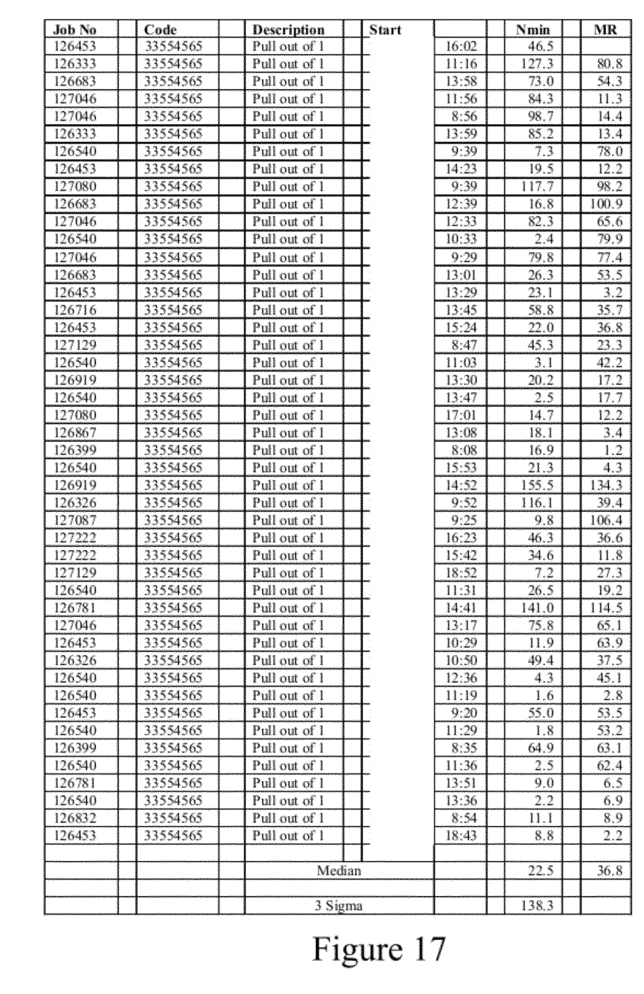

In step 920, the median data point from the received, sorted data is determined. In one exemplary embodiment, the analysis computer 100 calculates the median data point. FIG. 16 provides one exemplary method for how the analysis computer 100 calculates the median data point for the received, sorted data. The median value for the received, sorted data is determined in step 925. In one example, the analysis computer 100 calculates the median value for the received, sorted data. FIG. 17 provides one exemplary method for how the analysis computer 100 calculates the median value, which in this example is for completion times for POOH tubing.

In step 930, a determination is made for a lower level boundary (LLB) for the received sensor or time data. In one exemplary embodiment, the analysis computer 100 determines the lower level boundary based on a pre-set, pre-programmed level. In this exemplary embodiment, the pre-programmed level for the lower level boundary is the twenty-fifth percentile of received, ordered data points and is described as a quartile. The upper level boundary (ULB) for the received sensor or time data is determined in step 935. In one exemplary embodiment, the analysis computer 100 determines the upper level boundary based on a pre-set, pre-programmed level. In this exemplary embodiment, the pre-programmed level for the upper level boundary is the seventy-fifth percentile of received, ordered data points and is also described as a quartile. Thus, in the example above, only the fifty percent of data points closest to the median data point will be used for calculating the natural process limits and the moving range. FIG. 16 presents exemplary calculations for determining the lower level boundary and the upper level boundary based on the number of received and sorted data points in the 2^{nd} and 3^{rd} row. While the exemplary embodiment sets the lower level boundary at the twenty-fifth percentile, in alternative embodiments, the lower level boundary can be anywhere in a range between 1 and 49 percent. Further, while the exemplary embodiment sets the upper level boundary at the seventy-fifth percentile, in alternative embodiments the upper level boundary can be anywhere in a range between 51 and 99 percent.

Once the upper and lower level boundaries have been calculated for the particular activity, the analysis computer 100 reviews each of the data points to determine if they are between the upper and lower level boundaries. If the data is between the boundaries, the “data point between boundary” branch is followed to step 830. Otherwise, the “outside of boundary” branch is followed to step 945. The data points that are determined to be between the upper and lower level boundaries are sometimes referred to as the “center-cut data”.

In step 945, the inner quartile (IQ) is calculated. In one exemplary embodiment, the analysis computer calculates the inner quartile. Further, in one exemplary embodiment, the equation for determining the inner quartile is the value of the upper level boundary minus the value of the lower level boundary or ULB−LLB=IQ. The upper gross error boundary is determined in step 950. In one exemplary embodiment, the upper gross error boundary is determined by the analysis computer 100. In this exemplary embodiment, the upper gross error boundary is calculated as the product of the inner quartile and a constant (C), which is then added to the upper level boundary or ULB+(C*IQ). In one exemplary embodiment, the constant is a value of 1.5, however, other values ranging from 0.1-10 are within the scope and spirit of this disclosure. In step 955, the lower gross error boundary is determined. In one exemplary embodiment, the lower gross error boundary is determined by the analysis computer 100. In this exemplary embodiment, the lower gross error boundary is calculated as the product of the inner quartile and a constant (C), which is then subtracted from the lower level boundary or LLB−(C*IQ). In one exemplary embodiment, the constant is a value of 1.5, however, other values ranging from 0.1-10 are within the scope and spirit of this disclosure.

In step 960, the data points that were outside of the boundary in step 940 are selected and evaluated against the upper and lower gross error boundaries by the analysis computer 100. In step 965, an inquiry is conducted to determine if the value of each particular data point falls within the upper and lower gross error boundaries. This determination is typically made by the analysis computer 100. If the data point does not fall within the upper and lower gross error boundaries, the NO branch is followed to step 970, where additional analysis is conducted with regard to that particular data to determine if the data value for the instance of the activity is correct or needs to be adjusted. For example, the data can be sent to the rig operator or rig supervisor to evaluate and compare the electronic data against written records or other information to determine if the electronic data that fell outside of the boundaries was accurate. The process then continues to step 975. Returning to step 965, if the data value for the instance of the activity is within the upper and lower gross error boundaries, the YES branch is followed to step 975.

In step 975, an inquiry is conducted to determine if there is data for another instance of the activity. If so, the YES branch is followed to step 960. On the other hand, if there is not data for another instance of the activity to be evaluated, the NO branch is followed to step 905 to select another activity for evaluation.

FIG. 10 is a flow chart presenting a method 830 for conducting a tech limit activity review of sensor, time, or other activity data in accordance with one exemplary embodiment. Referring now to FIGS. 1-10 and 16, the exemplary method 830 begins at step 1005, where the analysis computer 100 sorts the center-cut data in chronological order. The median data point for the center-cut data is calculated in step 1010. In one exemplary embodiment, the calculation of the median data point is completed by the analysis computer 100. The median data value (M) is determined from the center-cut data in step 1015 and can be calculated or determined, for example, by the analysis computer 100. FIG. 16 presents an exemplary calculation of the median data point and median value for the exemplary center-cut data in the fourth row.

In step 1020, the moving range of the center-cut chronologically ordered data is determined. In one exemplary embodiment, the analysis computer 100 calculates the moving range for the center-cut, chronologically ordered data. In one exemplary embodiment, the moving range is the absolute value of the difference in two values in, for example, chronological order. Once the moving range has been calculated for the chronologically ordered data, the median (MMR) for the moving range is determined in step 1025. In certain exemplary embodiments, the median (mMR) for the moving range is calculated or determined by the analysis computer 100. In step 1030, if necessary, the upper natural process limit (UPL) is determined. In one exemplary embodiment, the determination is made by the analysis computer 100 and is calculated based on the equation UPL=M+(X*mMR), where X is a constant. In certain exemplary embodiments, the constant X is equal to t_{σ}, which is sometimes referred to in the art as 3-Sigma and in certain exemplary embodiments is equal to 3.145. Alternatively, the constant (X) can be any number between 0.5-10.

In step 1032, if necessary, the lower natural process limit (LPL) is determined. For certain data being evaluated it may only be compared to the UPL, the LPL, or it may be evaluated to determine if it is between a UPL and LPL. The analysis computer 100, for example, can be programmed to know which data from which activities need be compared to which individual or set of natural process limits. In the example discussed above regarding the data being completion times for a particular activity, for example, the analysis computer 100 calculates an upper natural process limit for completion time for the activity being analyzed based on the multiple instances of time completion data initially received by the analysis computer 100 in step 820 of FIG. 8. Row 5 of FIG. 16 presents and example calculation of the 3-Sigma value.

In step 1034, once the upper natural process limit, the lower natural process limit, or the upper and lower natural process limits have been calculated, the analysis computer 100 compares each value of the sensor data or time data to the upper and/or lower natural process limits. For example, using the completion time for each instance of the activity example above, only an upper natural process limit would be calculated and the completion times for each instance of the activity would be compared to the upper natural process limit to determine which completion times were greater than the upper natural process limit. Alternatively, for other types of sensor or time data, both upper and lower natural process limits or just lower natural process limits may be calculated and the sensor or time data may be compared to both upper and lower natural process limits or just the lower natural process limits as a basis for determining which instances include data that is outside of the natural process limit range.

An inquiry is conducted in step 1035 to determine if the data for a particular instance of the selected activity is within the particular natural process limit (i.e. less than the upper natural process limit, greater than the lower natural process limit or between the upper and lower natural process limits). In one exemplary embodiment, the determination is made by the analysis computer 100. Using the completion times scenario above as an example, if the completion time for the instance is greater than the upper natural process limit value, then it would be outside of the range and the NO branch is followed to step 1040, where the analysis computer 100 flags that instance or adds that instance of the activity to a list of out of range instances of the activity. The process then continues to step 1045. Returning to step 1035, if the completion time for the instance is less than or equal to the upper natural process limit value, then the value is within the range and the YES branch is followed to step 1045.

In step 1045, an inquiry is conducted by the analysis computer 100 to determine if there is another instance of the activity to compare to the natural process limits. If there is another instance, the YES branch is followed back to step 1030 to compare the data value of the next instance to the particular natural process limit(s). Otherwise, the NO branch is followed to step 1050. In step 1050, additional analysis is conducted on each instance of the activity that is not within the natural process limit range. This additional analysis can be completed by the analysis computer 100, one or more supervisors over the particular instance of the activity that was not within the natural process limit(s), or a combination of both. In certain exemplary embodiments, the additional analysis can include the supervisor or other person asking or answering questions to determine why the instance of the activity exceeded one of the natural process limits. This can include completing a set of drop down menus provided by the analysis computer 100 that describe possible reasons why the instance of the activity was outside of the natural process limit range. Additionally, a root cause analysis can be conducted to determine why the data for that particular instance of the activity was outside of the natural process limit range.

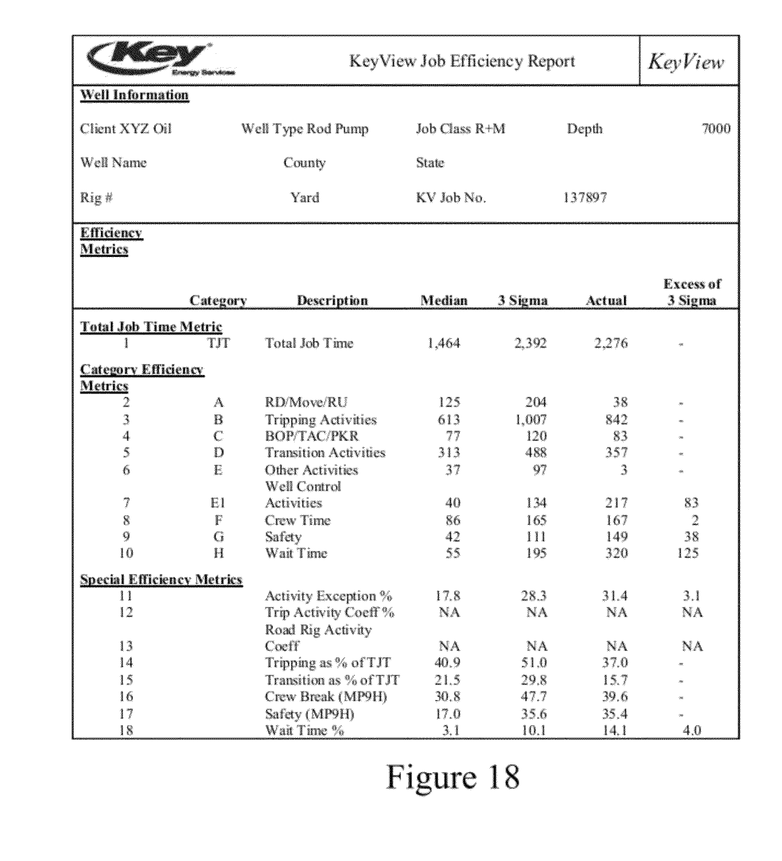

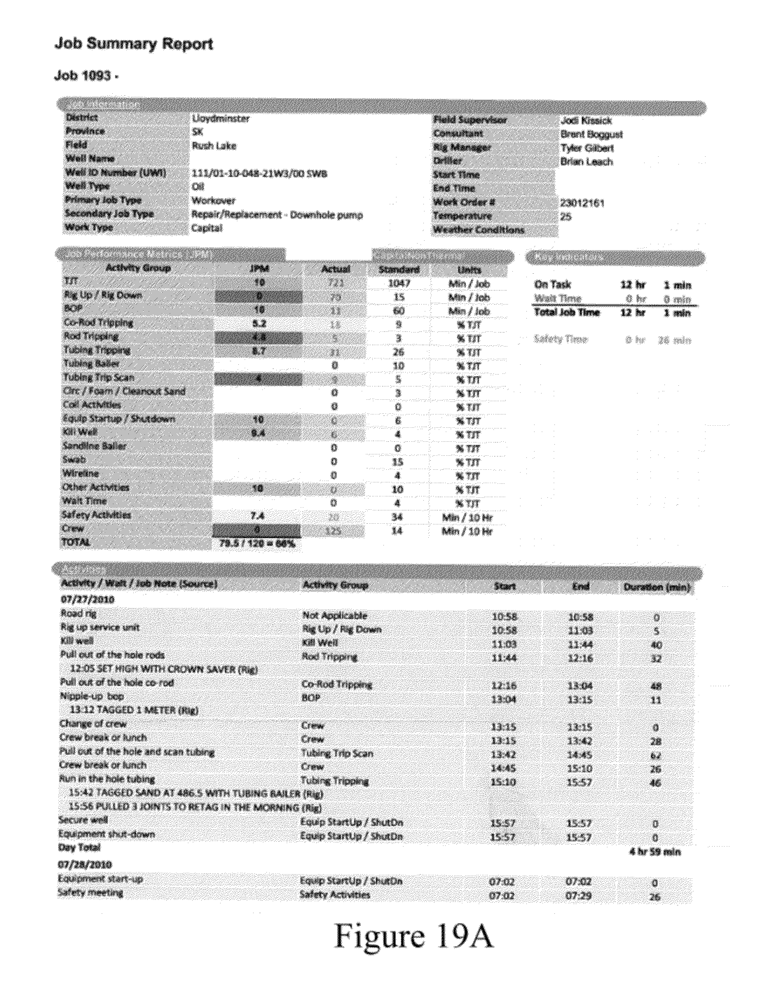

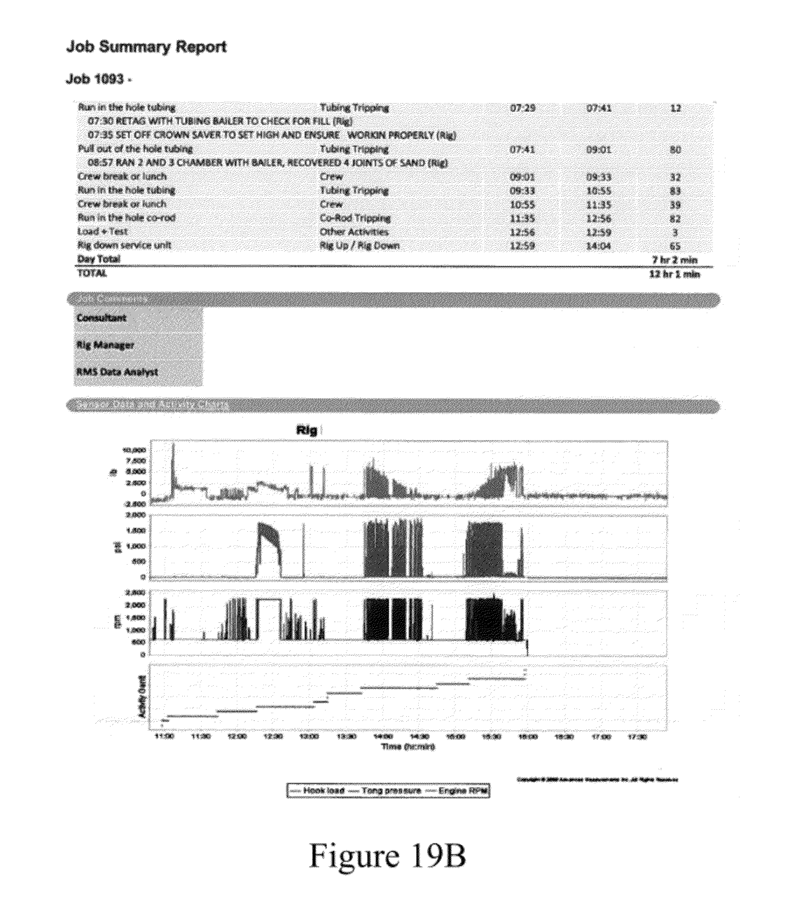

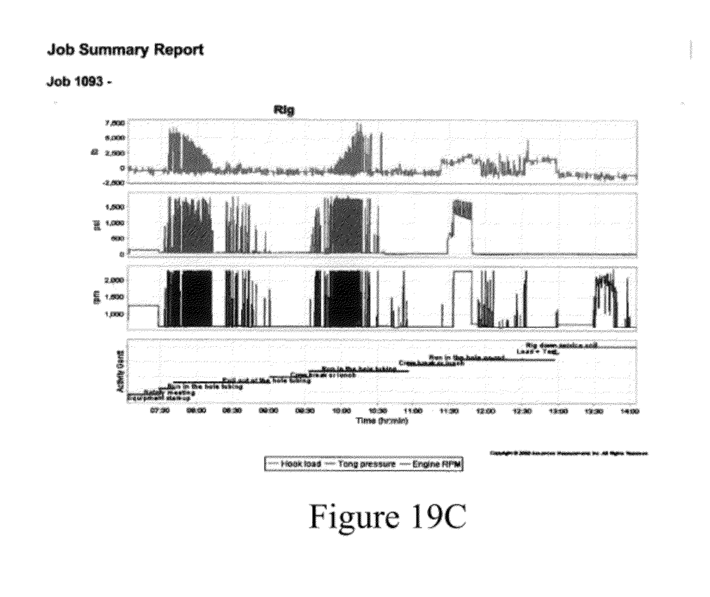

In step 1055, an inquiry is conducted to determine if there is another activity on which to conduct analysis. In one exemplary embodiment, the determination is made by the analysis computer 100 reviewing the data and the types of activity associated with the data in the database 705. If there is another activity, the YES branch is followed to step 820 of FIG. 8 to receive the data for multiple instances of the next activity. Otherwise, the NO branch is followed to step 835 of FIG. 8. In one exemplary embodiment, the analysis computer 100 continues to loop through the process until all of the activities have been analyzed. Based on the data obtained, the analysis computer 100 generates reports, such as the job efficiency report of FIG. 18 or the job summary report of FIGS. 19A-C.

FIG. 11 is a flow chart presenting an exemplary method for conducting additional analysis of sensor data or time data as described in step 1050 of FIG. 10. Referring to FIGS. 1-11, the exemplary method 1050 begins at step 1105 where the analysis computer 100 determines the supervisor for each instance of the activity that is determined to be outside of the natural process limit(s) range. In one exemplary embodiment, the instance in the database 705 can include additional information such as rig number, job number, job site location, supervisor or other identifying information to assist the analysis computer 100 in determining who the supervisor is for the particular instance that is out of range. In step 1110, the analysis computer 100 transmits a request to the supervisor to complete a root cause analysis routine. The root cause analysis routine can be sent by the analysis computer 100 to the supervisor with the request or a link can be provided, or the supervisor can access the root cause analysis routine remotely. The root cause analysis routine can be stored on the analysis computer 100 or another computer system capable of electronically communicating with the analysis computer 100.

A series of questions are provided to the supervisor based on the particular activity to determine the reason why the particular instance of the activity was outside of the natural process limit(s) range in step 1115. In one exemplary embodiment, the questions are provided by the analysis computer 100 in a set of drop down menus that describe possible reasons why the instance of the activity was outside of the natural process limit(s) range. Responses are accepted from the supervisor in step 1120 at, for example, the analysis computer 100 or another computer communicably coupled to the analysis computer 100. The responses are stored for later evaluation in step 1125. In one exemplary embodiment, the responses are stored in the database 705 by the analysis computer 100. The process then continues to step 1055 of FIG. 10.

FIG. 12 is a flow chart presenting an exemplary method for conducting data mining of sensor data or time data for activities as described in step 835 of FIG. 8. Referring now to FIGS. 1-8 and 12, the exemplary method 835 begins at step 1205 where the analysis computer 100 selects or receives data for a single instance of an activity from the database 705. For the ease of discussion, the following example will be described in reference to retrieving and evaluating instances of the time to complete a particular activity. However, the data mining process could also be used on other sensor and time data for the well service rig 20. In one exemplary embodiment, the data is obtained from the database 705. In step 1210, the elapsed time for the selected instance of the activity is reviewed. In one exemplary embodiment, this review is completed by the analysis computer 100. The analysis computer 100 designates the total time shown or elapsed for the selected instance as “Gross Time” in step 1215.

In step 1220, the analysis computer 100 evaluates other sensor data associated with this instance of the activity. In one exemplary embodiment, the other sensor data includes inputs or selections made by the operator at the display 610 of the computer 605, which can also be stored in the database 705. An inquiry is conducted in step 1225 to determine if the operator indicated any wait time while completing this instance of the activity. In one exemplary embodiment the indication of wait time can be made by an operator selecting one of the buttons on the display 610 of the computer 605. Alternatively, the analysis computer 100 can evaluate other sensor data, such as engine revolutions per minute (RPMs), hookload or rig weight from sensors 46, 102 and hydraulic pressure from sensor 80 to determine if the rig 20 was waiting during a particular activity. If wait time was indicated, the YES branch is followed to step 1230, wherein the analysis computer 100 subtracts the amount of wait time from the Gross Time to determine the “Net Time” to complete the particular instance of the activity. The process then continues to step 1235. Returning to step 1225, if no wait time is indicated or determined, the NO branch is followed to step 1235, where the analysis computer 100 analyzes sensor data to determine what portion of the Net Time the rig was operating on the designated activity. In one exemplary embodiment, the analysis computer 100 or the computer 605 evaluates block movement over time and gaps or lack of block movement over time. When the computer 100 or 605 determines that the block is not moving, it can designate that time that the rig 20 was not completing the activity. In certain exemplary embodiments, the computer 100 or 605, allows for a certain amount of no activity time from the block data before beginning to count that time as time that the rig is not completing the activity. For example, in one exemplary embodiment, the computer 100 or 605 waits until the block has not shown activity for two minutes, before beginning to count the time as time the rig 20 was not completing activity. In alternative embodiments, the baseline no activity time can be an amount other than two minutes, such as any amount of time between zero and twenty minutes. Once it determines that the block has not moved for longer than the designated amount of time, the computer 100 or 605 begins counting the subsequent no activity time and when the activity is completed, subtracts that time from the Net Time. In an alternative embodiment, instead of counting only the subsequent time, it can go back to the first moment that no activity was detected from the block and count that as the beginning of the no activity time which is then subtracted from the Net Time.

In step 1240, the analysis computer 100 designates the time determined that the rig 20 spent operating on the particular instance of the activity as Work Time. The trip activity coefficient is calculated in step 1245. In one exemplary embodiment, the trip activity coefficient is calculated based on the equation of Work Time divided by Net Time and is calculated by the analysis computer 100. In step 1250, the values for Gross Time, Wait Time, Net Time, Work Time and trip activity coefficient for this instance of the activity are digitally stored for later use. In one exemplary embodiment, these values are stored in the database 705 by the analysis computer 100. The analysis computer 100 determines the number of tubing, rods, or casing (referred to collectively hereinafter and in the claims as “tubing”) run into the hole or pulled out of the hole for this instance of the activity in step 1255.

In step 1260, an inquiry is conducted by, for example, the analysis computer 100 to determine if there is another instance of the activity in the database 705. If there is another instance, the YES branch is followed back to step 1205. Otherwise, the NO branch is followed to step 840 of FIG. 8. Alternatively, the NO branch could be followed to another inquiry to determine with the analysis computer 100 if there is another activity in the database 705 for which data mining can be completed. In that alternative, the YES branch would also be followed to step 1205 and the NO branch would be followed to step 840 of FIG. 8.

FIG. 13 is a flow chart presenting an exemplary method for determining a number of tubing joints pulled during an instance of a particular activity, as described in step 1255 of FIG. 12. Referring now to FIGS. 1-8, 12, and 13, the exemplary method 1255 begins at step 1305, where the analysis computer 1305 receives an activity signal. In one exemplary embodiment, the activity signal is received based on the rig operator selecting an activity at the display 610 which is then communicated and included with the data sent to the analysis computer 100. In step 1310, the start time of the tripping activity is received. For example, the start time can be received at the analysis computer 100 either from the database 705 or in real-time or nearly real time from the rig 20 by way of the modem 98. Alternatively, the determination of the number of tubing pulled out of or run into the well is determined at the computer 605. Similarly, the end time of the tripping activity is received in step 1315. The hook load, tong pressure, and block position sensor data is received in step 1320. In certain exemplary embodiments, the sensor data is received at the analysis computer 100. In step 1325, the tripping activity is classified. In one exemplary embodiment, the classification of the tripping activity is made by the rig operator by pressing or selecting one of the buttons on the display 610. This classification information is then transmitted to the database 705 or the analysis computer 100. The analysis computer 100 sets the tubing joint length based on the classification in step 1330.

In step 1335, the minimum block position for a single trip of running a tubing string into or out of the well is received and in step 1340 the maximum block position for the same trip is received. In one exemplary embodiment, the block position data is originates from the block position sensor 38 and the analysis computer 100 is able to analyzes the block position data to determine the minimum and maximum positions detected for each trip into or out of the well. The maximum hookload is determined and received at the analysis computer 100 in step 1345 and the minimum hookload for that same trip is determined and received at the analysis computer 100 in step 1350. In one exemplary embodiment, the maximum and minimum hookload are based on an evaluation of the sensor readings from the hydraulic pads 92 and the zero weight setting on the display 610 that are transmitted and stored in the database 705 or directly transmitted to the analysis computer 100. Alternatively, the hookload levels can be provided by other weight sensing means, such as for example, sensors or strain gauges on the block or line itself. The maximum tong pressure during the same trip is determined and received at the analysis computer 100 in step 1355. In one exemplary embodiment, the tong pressure data is received from the sensor 80 and the analysis computer 100 is able to review the series of tong pressure data to determine the maximum pressure sensed during the single trip.

In step 1360, an inquiry is conducted to determine the difference between the maximum hook load received for the trip and the minimum hookload received for the trip. In one exemplary embodiment, the difference is determined by the analysis computer 100 and the difference must be greater than or greater than or equal to a predetermined level or the trip will not be used for the purposes of counting the number of tubing joints. For example, the predetermined level can be five hundred pounds or any other amount between one hundred and ten thousand pounds. The determination of at least a minimum level of change in hookload during a trip is used by the analysis computer 100 to verify that one or more tubing joints was either added or removed from the tubing string during the particular trip. If the difference in the maximum and minimum hookload is less than the predetermined level, the NO branch is followed to step 1335. If the difference in the maximum and minimum hookload is greater than or greater than or equal to the predetermined level, then the YES branch is followed to step 1365. The analysis computer 100 determines the difference and compares the difference to the predetermined level, which can be preset into the computer 100 in one exemplary embodiment.

An inquiry is conducted in step 1365 to determine if the maximum tong pressure was greater than or greater than or equal to a predetermined tong pressure level. For example, the predetermined tong pressure level can be four hundred pounds per square inch (psi) or any other pressure level between one hundred and nine hundred psi. The determination of at least a predetermined level of tong pressure during the trip is used by the analysis computer 100 to verify that tongs were engaged to make up or break out a portion of the tubing string thereby adding or removing from the tubing string at least one tubing joint during the trip. If the maximum tong pressure is less than the predetermined tong pressure level, then the NO branch is followed to step 1335. However, if the maximum tong pressure is greater than or greater than or equal to the predetermined tong pressure level, then the YES branch is followed to step 1370. The analysis computer 100 compares the maximum tong pressure during the trip to the predetermined tong pressure level, which can be preset into the computer 100 in one exemplary embodiment.

In step 1370, the analysis computer 100 estimates the number of tubing joints based on the difference between the maximum and minimum block positions for the trip and the joint length. For example, the analysis computer can divide the difference between the maximum and minimum block position by the joint length and take the lowest or nearest integer value as an estimate of the number of tubing joints. In step 1375, an inquiry is conducted to determine if there is another tripping cycle in the data for the particular instance of the tripping activity. If so, the YES branch is followed to step 1335. Otherwise, the NO branch is followed to step 1380, where the analysis computer 100 sums up the total number of estimated tubing joints pulled out of or run into the well for all of the trips during the particular instance of the activity. In step 1380, the analysis computer 100 stores the number of tubing joints or stands with the other data for this instance of the activity. In one exemplary embodiment, the data is stored in the database 705 or internally on the computer 100. The process then continues to step 1260 of FIG. 12.

FIG. 14 is a flow chart presenting a method for verifying that a tubing anchor catcher was set correctly according to one exemplary embodiment. Referring now to FIGS. 1-14, the exemplary method 1400 begins at step 1405, where the analysis computer 100 reviews mined data in the database 705. Based on the evaluation of the mined data, the analysis computer 100 finds instances of activities where the activity includes setting the tubing anchor catcher (TAC) in step 1410 and retrieves and/or evaluates the data for those instances. In certain exemplary embodiments, the rig operator selects the set TAC activity at the display 610 and this information about the activity is stored in the database 705. In step 1415, the rig weight or hookload data is evaluated. In one exemplary embodiment, this data is evaluated by the analysis computer 100.

An inquiry is conducted in step 1420 to determine if there is a section of the rig weight or hookload data where the hookload increases to the string weight and holds at that string weight for a short period of time. In one exemplary embodiment, the analysis and determination are made by the analysis computer 100, the string weight is typically the amount of weight for the particular activity (such as the amount of weight that is determined when the tubing string is initially picked up (minus the weight of the rig if rig weight sensors are being evaluated)) and the short period of time is anywhere in the range of one second to five minutes. If there is no such section of data, the NO branch is followed to step 1415. Otherwise, the YES branch is followed to step 1425, where the analysis computer 100 reviews data in the database 705 from the block position sensor 38 to determine a first period when the block is moving up. In the area, that the block position data is moving up, the analysis computer reviews data from the rig weigh or hookload sensors 46, 102 to determine if within that first period the hookload or rig weight increases a nominal amount in step 1430. In one exemplary embodiment, a nominal increase is about 5,000 pounds. In alternative embodiments, the nominal increase can be anywhere in the range of 1500-50,000 pounds and will typically be based on the manufacturer's specified guidelines for the particular tubing anchor.

In step 1435, the analysis computer 100 reviews block position data to determine if a second period exists, after the first period, where block movement is down and evaluates the hookload or rig weight data during that second period to determine if the hookload or rig weight decreases a second nominal amount. In one exemplary embodiment, a second nominal decrease is about 10,000 pounds. In alternative embodiments, the second nominal decrease can be anywhere in the range of 1500-50,000 pounds and will typically be based on the manufacturer's specified guidelines for the particular tubing anchor. In step 1440, the analysis computer 100 reviews block position data to determine if a third period exists, after the second period, where block movement is up and evaluates the hookload or rig weight data during that third period to determine if the hookload or rig weight increases a third nominal amount. In one exemplary embodiment, a third nominal increase is about 15,000 pounds (or 10,000 pounds over string weight). In alternative embodiments, the third nominal increase can be anywhere in the range of 1500-80,000 pounds and will typically be based on the manufacturer's specified guidelines for the particular tubing anchor.

In step 1445, the analysis computer 100 reviews block position data to determine if a fourth period exists, after the third period, where block movement is down and evaluates the hookload or rig weight data during that fourth period to determine if the hookload or rig weight decreases a fourth nominal amount. In one exemplary embodiment, a fourth nominal decrease is about 20,000 pounds (or 10,000 pounds below string weight). In alternative embodiments, the fourth nominal decrease can be anywhere in the range of 1500-80,000 pounds and will typically be based on the manufacturer's specified guidelines for the particular tubing anchor. In step 1450, the analysis computer 100 reviews block position data to determine if a fifth period exists, after the fourth period, where block movement is up and evaluates the hookload or rig weight data during that fifth period to determine if the hookload or rig weight increases a fifth nominal amount. In one exemplary embodiment, a fifth nominal increase is about 20,000 pounds (or 10,000 pounds above string weight). In alternative embodiments, the fifth nominal increase can be anywhere in the range of 1500-80,000 pounds and will typically be based on the manufacturer's specified guidelines for the particular tubing anchor.

In step 1455, the analysis computer 100 reviews block position data to determine if a sixth period exists, after the fifth period, where block movement and the hookload or rig weight data during that fifth period are substantially stable for a predetermined period of time. In one exemplary embodiment, the predetermined period of time is three minutes or longer. In alternative embodiments, the predetermined period of time can be anywhere in the range of ten seconds to twenty minutes and will typically be based on the manufacturer's specified guidelines for the particular tubing anchor. In step 1460, if all of the determinations in steps 1415-1455 have been verified by the analysis computer, the computer 100 generates a positive notification that the TAC was set properly. In one exemplary embodiment, the notification can take the form of a designation on a report card by way of individual designation of the instance of the TAC activity and a notification of passing or success on the report card or alternatively as an increase in the count of set TAC instances that were completed properly. Similarly, if one or more of the determinations in steps 1415-1455 were not verified, the analysis computer generates a negative notification that the TAC was not set properly in a manner similar to those described above when the TAC is set properly.

In step 1460, an inquiry is conducted by the analysis computer 100 to determine if there is another instance where the set TAC activity was being completed in the database 705. If so, the YES branch is followed to step 1415. Otherwise, the NO branch is followed to step 840 of FIG. 8.

Although the invention is described with reference to preferred embodiments, it should be appreciated by those skilled in the art that various modifications are well within the scope of the invention. Therefore, the scope of the invention is to be determined by reference to the claims that follow. From the foregoing, it will be appreciated that an embodiment of the present invention overcomes the limitations of the prior art. Those skilled in the art will appreciate that the present invention is not limited to any specifically discussed application and that the embodiments described herein are illustrative and not restrictive. From the description of the exemplary embodiments, equivalents of the elements shown therein will suggest themselves to those or ordinary skill in the art, and ways of constructing other embodiments of the present invention will suggest themselves to practitioners of the art. Therefore, the scope of the present invention is to be limited only by any claims that follow.

We claim:

1. A computer-implemented method for evaluating data from a well service rig comprising the steps of:
receiving, at an at least one analysis computer, a collection of data, wherein the collection of data includes data for a plurality of instances of an activity completed by a well service rig at a wellsite;
conducting, with the at least one analysis computer, a gross error review of the collection of data;
conducting, with the at least one analysis computer, a tech limit activity review of the collection of data; and
generating, with the at least one analysis computer, a report for the instances of the activity.

2. The method of claim 1, further comprising the steps of:
providing the well service rig at the wellsite;
conducting an instance of an activity with the well service rig;
receiving a plurality of data from a plurality of sensors at the wellsite while conducting the instance of the activity;
transmitting the plurality of data to an area remote from the wellsite; and
storing the plurality of data for the instance of the activity in the data storage device.

3. The method of claim 1, wherein the gross error review comprises the steps of:
sorting, with the at least one analysis computer, the collection of data from a lowest value to a highest value;
determining, with the at least one analysis computer, a first median data point for the collection of data;
determining, with the at least one analysis computer, a first median data value for the collection of data;
applying, with the at least one analysis computer, a lower level boundary to the sorted collection of data based on a first pre-programmed percentage;
applying, with the at least one analysis computer, an upper level boundary to the sorted collection of data based on a second pre-programmed percentage; and
selecting, with the at least one analysis computer, all data points in the sorted collection of data between the lower level boundary and the upper level boundary.

4. The method of claim 1, wherein the first pre-programmed percentage is within a first range between 15 percent and 35 percent and wherein the second pre-programmed percentage is within a second range between 15 percent and 35 percent.

5. The method of claim 3, wherein the tech limit activity review of the collection of data further comprises the steps of:
sorting, with the at least one analysis computer, the selected data in a chronological order;
determining, with the at least one analysis computer, a second median data point for the selected, chronologically ordered data;
determining, with the at least one analysis computer, a second median value for the selected, chronologically ordered data;
calculating, with the at least one analysis computer, a moving range for the selected, chronologically ordered data;
calculating, with the at least one analysis computer, a median of the moving range; and
calculating an upper natural process limit, with the at least one analysis computer, based on the sum of the second median value and a product of a constant and the median of the moving range; and
comparing, with the at least one analysis computer, data values for each instance of the collection of data against the upper natural process limit, wherein data values above the upper natural process limit are out of range.

6. The method of claim 5, further comprising the steps of:
calculating a lower natural process limit, with the at least one analysis computer, based on the difference of the second median value and the product of a constant and the median of the moving range;
comparing, with the at least one analysis computer, data values for each instance of the collection of data against the lower natural process limit; and
designating, with the at least one analysis computer data values below the lower natural process limit as out of range.

7. The method of claim 5, further comprising the steps of:
adding information about each instance of the activity with data out of range to an out of range list;
conducting additional analysis on each instance of the activity on the out or range list;

8. The method of claim 1, further comprising the step of determining, with the at least one analysis computer, a benchmark for the activity based on tech limit activity review of the collection of data.

9. The method of claim 1, further comprising the steps of:
determining, with the at least one analysis computer, if there is another activity having data for a plurality of instances of the another activity in the data storage device; and
repeating the steps of claim 1 for each additional activity.

10. A computer-implemented method for determining a trip activity coefficient for an activity completed by a well service rig comprising the steps of:
receiving, at an at least one analysis computer, a plurality of data for a single instance of the activity completed by the well service rig;
evaluating, with the at least one analysis computer, a first portion of the plurality of data to determine a gross time to complete the activity;
evaluating, with the at least one analysis computer, a third portion of the plurality of data to determine a portion of the gross time the well service rig conducted operations during the instance of the activity and designating that portion of the gross time as a work time; and
calculating, with the at least one analysis computer, the trip activity coefficient.

11. The method of claim 10, further comprising the steps of:
providing the well service rig at the wellsite;
conducting the instance of the activity with the well service rig;
receiving the plurality of data from a plurality of sensors at the wellsite while conducting the instance of the activity;
transmitting the plurality of data to an area remote from the wellsite; and
storing the plurality of data for the instance of the activity in the data storage device.

12. The method of claim 10, further comprising the steps of:
evaluating, with the at least one analysis computer, a second portion of the plurality of data to determine an amount of wait time occurring during the instance of the activity;
calculating, with the at least one analysis computer, the difference of the gross time and the amount of wait time as a net time; and
wherein calculating the trip activity coefficient comprises calculating the quotient of the work time divided by the net time.

13. The method of claim 12, further comprising the step of storing, with the at least one analysis computer, the gross time, wait time, net time, work time and trip activity coefficient for the instance of the activity in the data storage device.

14. The method of claim 10, wherein calculating the trip activity coefficient comprises calculating the quotient of the work time divided by the gross time.

15. The method of claim 10, further comprising the step of calculating, with the at least one analysis computer, a total number of tubing joints run during the instance of the activity.

16. The method of claim 15, wherein calculating the total number of tubing joints comprises the steps of:
receiving, at the at least one analysis computer, a plurality of tripping data comprising a plurality of trips of running tubing into or out of the well;
determining a joint length for each tubing joint run into or out of the well for each trip, receiving, at the at least one analysis computer, a first data value representing a minimum block position sensed during the trip;
for each trip, receiving, at the at least one analysis computer, a second data value representing a maximum block position sensed during the trip;
for each trip, calculating, at the at least one analysis computer, a difference between the second data value and the first data value as a block movement value;
for each trip, calculating to a nearest integer, at the at least one analysis computer, a quotient of the block movement value divided by the joint length as a tubing joint count for the trip; and
calculating as a total tubing joint value, at the at least one analysis computer, a sum of the tubing joint count for the plurality of trips.

17. The method of claim 16, further comprising the steps of:
for each trip, receiving, at the at least one analysis computer, a third data value representing a maximum load sensed during the trip;
for each trip, receiving, at the at least one analysis computer, a fourth data value representing a minimum load sensed during the trip;
for each trip, receiving, at the at least one analysis computer, a fifth data value representing a maximum pressure for a tongs during the trip;
for each trip, comparing, at the at least one analysis computer, a difference between the third data value and the fourth data value is greater than a load threshold value;
for each trip, determining, at the at least one analysis computer, if the fifth data value is greater than a pressure threshold value; and
for each trip, determining, with the at least one analysis computer, that zero tubing joints were run into or pulled out of the well if the difference between the third data value and the fourth data value is not greater than the load threshold value and if the fifth data value is not greater than the pressure threshold value.

18. The method of claim 17, wherein the load threshold value is between one hundred pounds and ten thousand pounds.

19. The method of claim 17, wherein the pressure threshold value is between one hundred and nine hundred pounds per square inch.

20. A computer-implemented method for determining if a tubing anchor was set properly by a well service rig comprising the steps of:
a. receiving, at an at least one analysis computer, a plurality of load data collected during an instance of setting the tubing anchor with the well service rig;
b. receiving, an the at least one analysis computer, a plurality of block position data collected during the instance;
c. evaluating, with the at least one analysis computer, the plurality of load data to determine if there is a first portion of the plurality of load data that increases to a string weight;
d. evaluating, with the at least one analysis computer, the plurality of block position data to identify a first period where a first portion of the plurality of block position data identifies that a block is moving upward;
e. evaluating, with the at least one analysis computer, the plurality of load data to determine if during the first period, a load represented by the load data increases a first nominal amount;
f. evaluating, with the at least one analysis computer, the plurality of block position data to determine if a second period exists after the first period where a second portion of the plurality of block position data identifies that the block is moving downward;
g. evaluating, with the at least one analysis computer, the plurality of load data to determine if during the second period, the load represented by the load data decreases a second nominal amount;
h. evaluating, with the at least one analysis computer, the plurality of block position data to determine if a third period exists after the second period where a third portion of the plurality of block position data identifies that the block is moving upward;
i. evaluating, with the at least one analysis computer, the plurality of load data to determine if during the third period, the load represented by the load data increases a third nominal amount;
j. evaluating, with the at least one analysis computer, the plurality of block position data to determine if a fourth period exists after the third period where a fourth portion of the plurality of block position data identifies that the block is moving downward;
k. evaluating, with the at least one analysis computer, the plurality of load data to determine if during the fourth period, the load represented by the load data decreases a fourth nominal amount;
l. evaluating, with the at least one analysis computer, the plurality of block position data and the plurality of load data to determine if a fifth period exists after the fourth period where a fifth portion of the plurality of block position data and a fifth portion of the plurality of load data are substantially stable for a predetermined amount of time; and
m. generating a positive notification that the tubing anchor was set properly based on a positive determination in steps c-1.

21. The method of claim 20, wherein the predetermined amount of time is at least three minutes.

22. The method of claim 20, wherein the first nominal amount, second nominal amount, third nominal amount, and fourth nominal amount are each between 1500 pounds and 80,000 pounds.
